(19) United States
(12) Patent Application Publication
(10) Pub. No.: US 2004/0201983 A1
(43) Pub. Date: Oct. 14, 2004

(54) Directable beam miniature led flashlight

(76) Inventor: Sun Yu, Berkley, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/408,296

(22) Filed: Apr. 8, 2003

(51) Int. Cl. F21L 2/00; F21L 4/04

(52) U.S. Cl. 362/157

(57) ABSTRACT

A directable beam flashlight includes a battery having opposite surfaces of opposite polarity. A light emitting diode having two leads extending therefrom is adapted to engage the opposing surfaces of the battery. A body panel is adapted to receive the battery and the light emitting diode. A frame attached to the body has an apical hook portion configured to orient the light emitting diode generally horizontal upon suspension of the flashlight by the hook portion.

### FIELD OF THE INVENTION

The present invention relates to miniature flashlights and, more particularly, to a reusable flashlight having a directable beam while using a coupled device.

### BACKGROUND OF THE INVENTION

With the advent of light emitting diodes (LEDs), compact, high flux illuminating devices became available. These illuminating devices have traditionally been constructed with two complementary shell components encasing an LED and a battery with an aperture in one component for a finger-activated button. Owing to the simple nature of these “clamshell” devices, sonic welding or adhesives are used to permanently seal the illuminating device. Upon expending the battery or damage to a device component, such illuminating devices are discarded thereby adding to the consumer waste stream.

There exists growing appreciation for the need to minimize waste streams and, in particular, waste streams such as batteries that over time may leak acids or toxic metals. Further, a device with interchangeable and replaceable components justifies further engineering to provide a more reliable and adaptable illuminating device.

While miniature high flux LED flashlights offer a light source that is readily transported as articles such as a key chain, operation of such a conventional LED flashlight with simultaneous manipulation of objects remains challenging. Prior art miniature LED flashlights have proven cumbersome to grasp and activate with thumb or finger pressure, all while attempting to manipulate a key towards a lock or carry packages. Alternatively, prior art miniature flashlights have been attached to other objects by way of a chain terminating in a selectively opened ring. Such designs suffer light source rotation about the chain while suspended from the ring thereby creating an unsteady light source. Thus, there exists a need for a miniature LED flashlight that can remain illuminated without manual pressure and casts a steady horizontal beam when suspended from an attached key or belt loop.

### SUMMARY OF THE INVENTION

A directable beam flashlight includes a battery having opposing surfaces of opposite polarity, and a light emitting diode having a first lead and a second lead extending from the diode. The light emitting diode leads are adapted to engage the opposing surfaces of the battery. A body is adapted to receive the battery and the LED. A frame attached to the body has an apical hook portion that is configured to orient the LED generally horizontal upon suspension of the flashlight by the hook portion. A generally horizontal light beam is emitted from the light emitting diode upon activation. Thus, an inventive flashlight is capable of casting a generally horizontal light beam upon suspending the flashlight from the hook portion such that a user's hand is free to engage an article coupled to the hook portion such as a key. Alternatively, the hook portion engages a garment to cast a hands-free directable beam.

### BRIEF DESCRIPTION OF THE DRAWINGS

FIG. 1 is a side view of a miniature LED flashlight according to the present invention;

FIG. 2 is an exploded view of the embodiment of the present invention depicted in FIG. 1;

FIG. 3 is a perspective view of the embodiment of the present invention depicted in FIG. 1; and

FIG. 4 is a perspective view of an LED support collar, according to the present invention.

### DETAILED DESCRIPTION OF THE PREFERRED EMBODIMENTS

With reference now to the figures, the overall flashlight of the present invention is shown at 10. A light emitting diode (LED) 14 is bounded by a frame 16. The LED being of any color including red, yellow, blue and white. A GaN LED is particularly preferred owing to the ophthalmic sensitivity to blue and the intensity thereof. The frame is attached to a unitary, clamshell or other type of flashlight body conventional to the art. Preferably, the frame 16 is intermediate between a lower panel 18 and an upper panel 20. The upper panel 20 having an aperture 24. The aperture 24 adapted to receive the boss portion 26 of a switch generally shown at 28. The frame 16 is formed to define a terminal hook portion 30. Pivotal attachment of a spring clip 32 to a portion of the frame 16 urges the spring clip 32 into pivotable contact with the hook portions 30 of the frame 16. The metallic spring 32 inserting into offset holes 34 within the frame 16. Rotation of metallic spring 32 about the offset and opposing holes 34 exerts a spring-like tension on the hook portion 30. It is appreciated that an inventive embodiment having a plurality of hook portions 30 need not be like shaped, each hook portion 30 independently is formed to have a single apex when suspended vertically. Illustrative hook portion shapes include a triangle, parallelogram and semicircle.

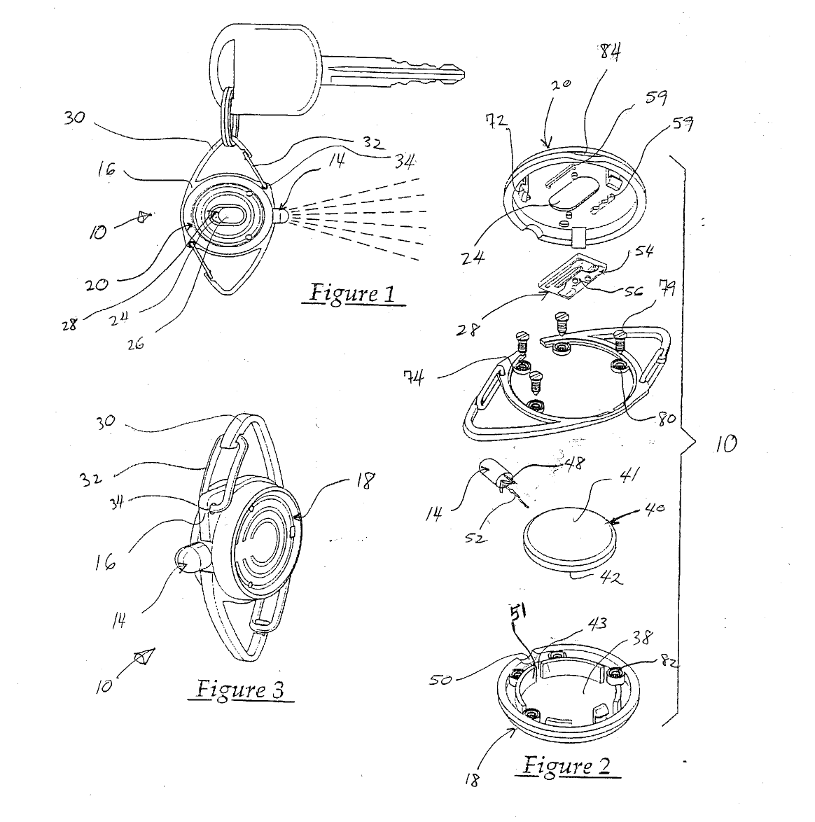

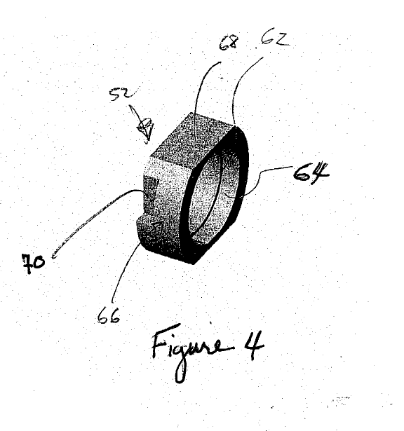

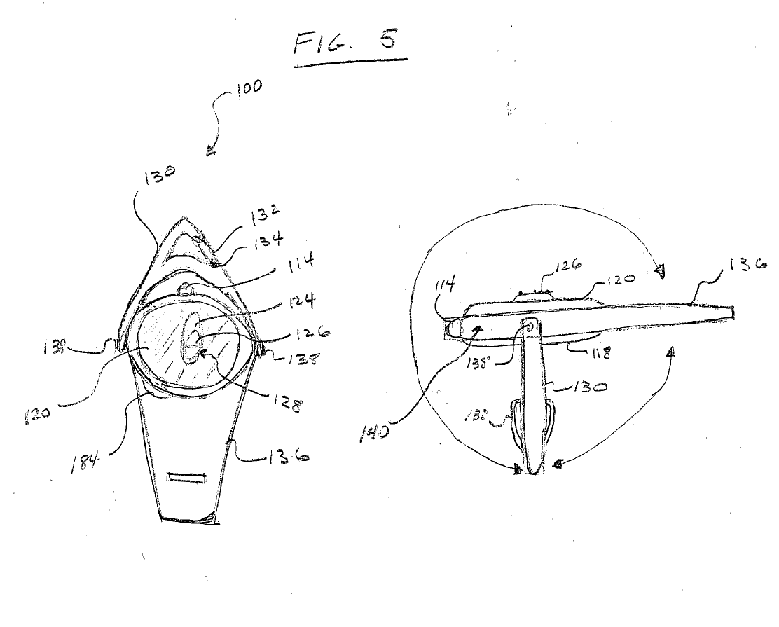

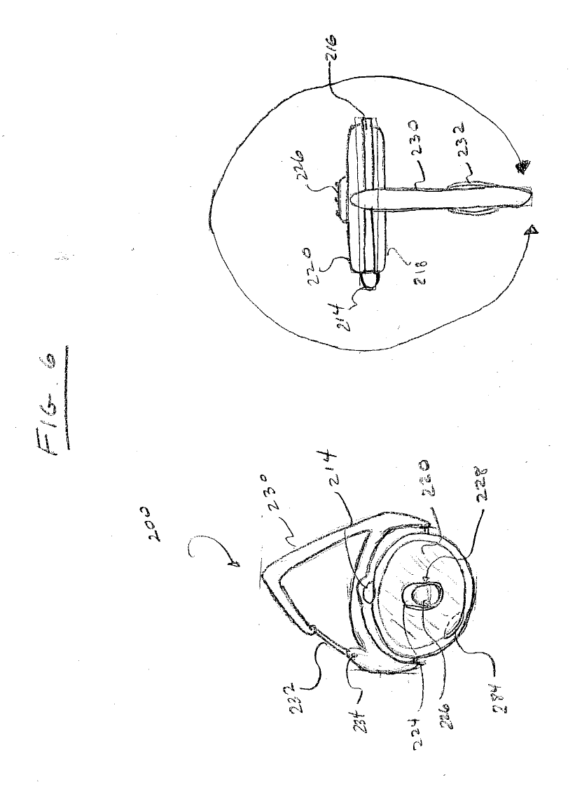

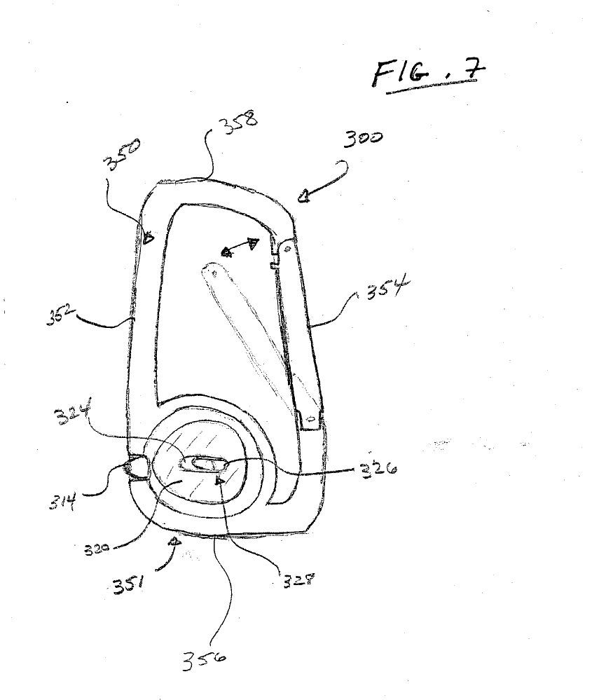

A hook portion according to the present invention is intended to provide a directed LED light beam when the inventive flashlight is suspended from an attached key ring. Preferably, an inventive flashlight provides a horizontal light beam when suspended, as shown in FIG. 1, thereby allowing a user to have a steady source of illumination from the suspended inventive flashlight while grasping only an attached key. Optimally, an inventive flashlight has two opposing hook portions with a second hook portion being free to attach to garments without the possibility of dislodging a key ring in the process. By way of example, an inventive flashlight is readily coupled to a hip belt loop thereby providing a source of lightweight, hand-free illumination.

Preferably, the frame 16 is metal. A metallic frame according to the present invention is cast from a metal illustratively including pot metal, aluminum, steel, pewter and brass. It is appreciated that a metallic frame according to the present invention is also readily formed through machining of a blank. Optionally, a frame according to the present invention is also formed of high ductility, high strength polymeric materials illustratively including epoxy, polycarbonate, LEXAN (Du Pont de Nemours and Company), fiber reinforced or metallic granulate reinforced forms thereof, and mixtures thereof. More preferably, a frame according to the present invention is formed from cast pot metal. Optionally, the frame is plated or otherwise coated to impart a protective or decorative appearance thereto.

The lower panel 18 is formed of an injected moldable thermoplastic material. Optionally, the lower or upper panel according to the present invention is formed of a translucent thermoplastic. The lower panel 18 has a recess 38 adapted to receive a button type battery 40 having a first pole face 41 and an opposite polarity face 42. Typically, the battery used herein is a lithium battery. The sidewalls of the recess 38 have a slot 43 therein, the slot 43 spaced to allow a lead 48 of the LED 14 to come into electrical contact with one pole of the battery 40. A terminal recess 50 is adapted to receive the LED 14. In a preferred embodiment, the LED 14 is supported within a collar 51, so as to transfer impact forces exerted on LED 14 into the frame 16, or lower panel 18 thereby inhibiting an impact to the LED 14 from acting as a fulcrum to pop upper panel 20 free from the flashlight 10. A second lead 52 of the LED 14 is supported by a portion of the lower panel 18 so as to afford selective electrical contact between the second lead 52 and the opposing pole 42 of the battery 40 via switch element 28. In a preferred embodiment, selective electrical contact between the second lead and the opposing pole of the battery 40 is provided by a leaf spring 54. The leaf spring 54 having an anchoring portion 56 attached to the switch element 28. By placing a transverse pressure on the leaf spring 54, the conductive leaf spring simultaneously contacts the second LED lead 52 and the opposing battery pole 42 thereby completing an electrical circuit and energizing the LED 14. The leaf spring 54 is urged into simultaneous contact with the second LED lead 52 and the opposite pole 42 of the battery 40 by the switch 28. The switch 28 held in relative position to the leaf spring by guide rails 59 formed in the lower side of upper panel 20. The boss 26 extending from switch 28 extends through aperture 24 of the upper panel 20. The boss 26 slides within aperture 24 with the application of lateral pressure to the boss. The switch 28 has a pedestal 62 extending beneath the boss 26 adapted to retain the boss 26 within the flashlight 10. It is appreciated that other types of springs including coil springs, button springs and the like, as well as other switch arrangements, are operative herein to afford both intermittent and continuous activated conditions of a LED.

In a preferred embodiment, the flashlight 10 according to the present invention is resealable after disassembly to component parts. The ability to reseal the flashlight 10 after disassembly allows for the replacement of expended batteries or other components. According to the present invention, an upper panel and frame are interconnected through complementary snap fittings molded into the upper and lower panels. With reference to FIG. 2, at least two snap fittings 72 extend from the upper panel 20. The upper panel snap fittings 72 engage complementary ridges 74 extending from the lower panel 18 or frame 16. More preferably, the lower panel 18 and the frame 16 are selectively secured with a threaded fastener 79 engaging a hole 80 in the frame 16 and a complementary tapped hole 82 in the lower panel 18.

Disassembly of the flashlight 10 is facilitated by a notch 78 located in the upper panel 20. The notch 84 is parallel to the frame 16 and a wall of the notch is defined by the frame. The notch 84 is adapted to receive a coin edge, key, paperclip or other small article, the article serving as a lever for separating the upper panel 20 from the remainder of the flashlight 10. Through the use of the notch 84, the flashlight 10 is readily disassembled without resort to specialized tools such as a jeweler's screwdriver.

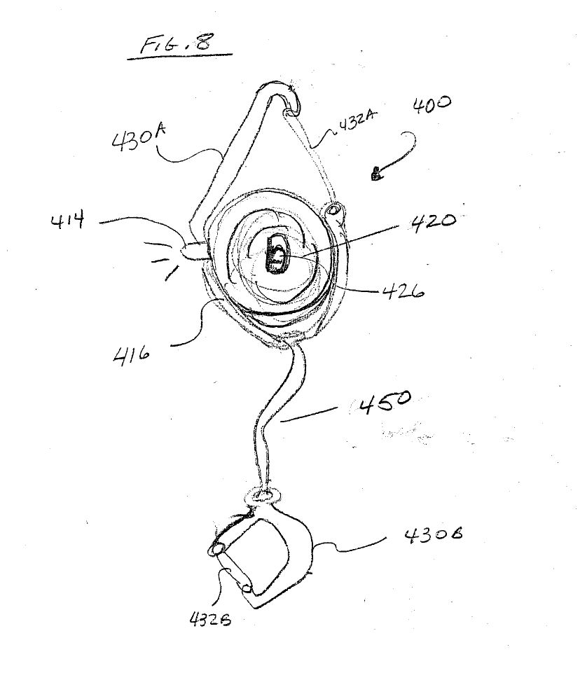

Referring now to FIG. 4, a collar is shown generally at 52. The collar 52 has an inner diameter 62 adapted to receive an LED 14 therein to transfer the impact forces received to the LED to the flashlight body thereby preventing a glancing impact on the LED from forcing the flashlight body apart. An LED having a base flange is preferably accommodated by a complementary recess 64 within the inner diameter 62. The outer surface 66 of a collar 52 has a flattened portion 68. The flattened portion arrests rotation of an LED so as to exert forces against LED leads. More preferably, the outer surface 66 has contours 70 to physically secure against a flashlight body component such as a panel or frame. It is appreciated that a collar according to the present invention can surround a portion of an LED diameter, or be formed of two or more complementary pieces.

FIG. 5 illustrates a first alternative embodiment 100 wherein the miniature LED flashlight 10 includes a single hook portion 130 pivotally attached to an LED flashlight and whistle body 136.

The whistle body 136 is preferably formed of the same material as the hook portion 130 of the LED flashlight 10 and includes a frame portion for the LED flashlight. The whistle body 136 and LED flashlight may be assembled as according to the preferred embodiment wherein the lower panel 118 and the whistle body 136 are selectively secured with a threaded fastener that engages a hole in the frame portion 140 of the whistle body and a complementary tapped hole in the lower panel 118. Accordingly, the upper panel 120 and whistle body 136 are interconnected through complementary snap fittings for engaging ridges extending from the lower panel 118 or frame portion 140 of the whistle body 136.

The frame portion 140 of the whistle body 136 further includes a recessed portion 184 that complements the notch formed in the upper panel 120 of the LED flashlight 10 such that an article for separating the upper panel 120 from the remainder of the flashlight may be easily received into the notch.

The hook portion 130 attaches to the whistle body 136 at diametrically opposing points 138 relative to the flashlight body. Preferably, the hook 130 is attached with a threaded fastener that engages complementary threaded holes within the frame portion 140 of the whistle body 136 such that the hook portion 130 is allowed to pivot freely about the diametric axis of the flashlight body that extends between the two fastening points 138.

The hook portion 130 frictionally engages the whistle body 136 such that the frictional force between the whistle body 136 and hook portion 130 act to selectively hold the whistle body 130 at a 90° angle relative to the apical of the hook portion 130.

It is appreciated that the primary purpose of the whistle body 136 is to serve the user as an instrument for making a distress signal or emergency alarm when a dangerous or threatening situation is perceived. The high pitched tone made by the whistle body 136 serves to ward off predators as well as attract the attention of those who can provide assistance to the user.

A second alternative embodiment 200 of the miniature LED flashlight is best illustrated in FIG. 6. A terminal hook portion 230 is fixedly attached to a circular frame 216 that receives the upper 220 and lower panel 218 of the miniature LED flashlight in a like manner described above. The circular frame 216 is diametrically attached to the hook portion 230 such that the LED flashlight is allowed to spin freely through a 360° angle in either direction about the diametric axis.

In this embodiment, the LED flashlight can be easily manipulated with one hand such that illumination can be directed in any direction with minimal effort and dexterity of the hand. As such, the LED flashlight provides a convenient means of illumination which may become necessary for locating dropped objects in darkened areas such as car garages or darkened rooms. The small size and weight of the LED flashlight and single hook portion 230 allows the user to conveniently carry the invention in a pant or jacket pocket with minimal obtrusiveness or discomfort.

A third alternative embodiment 300 generally comes in the form of a carabiner such as that used in rock climbing. As best illustrated in FIG. 7, a D-type carabiner 350 includes a flashlight frame portion 351 adjacent its lower asymmetric end 356 at its solid side 352 and away from its spring loaded gated side 354. When suspended by the apical portion 358 of the carabiner 350, the LED flashlight is capable of casting a generally horizontal light beam upon the face of the object being climbed. The spring loaded gate 354 is opened to receive the climber's rope into the carabiner 350 where it rests adjacent the LED flashlight without obstruction to its illumination. Alternatively, this embodiment may serve as an ideal companion for biking, hiking, jogging and working. The large spring loaded gate 354 allows the carabiner 350 and LED flashlight combination to clip on and off virtually anything. In either case, the LED flashlight may be used to provide needed illumination in substantially dark conditions.

The carabiner 350 and frame portion 351 are made of a solid metallic material, preferably aluminum, although other materials may be used as known to those skilled in the art. Here again, the upper 320 and lower 318 panels of the LED flashlight are secured to the frame 351 in a manner as described above with fasteners and complementary snap fittings.

A fourth alternative embodiment 400 provides a miniature LED flashlight that has first 430A and second 430B opposing hook portions wherein the second hook 430B portion is attachable to an object or a garment while being mechanically attached to the LED flashlight frame and first hook portion 430A via a retractable cord 450. In this manner the user may simply grab hold of the miniature flashlight to extend the retractable cord 450 to a desired length where the cord 450 is latched for the desired use of the flashlight. To retract the cord 450, a release switch is pushed or other conventional means may be employed, by the user that causes the cord to retract to its original position. As such, the LED flashlight is always readily available to the user without having to search through pocketbooks or garment pockets and is easily manipulated with one hand while holding an object in the other. Also, an inconvenience resulting from accidentally dropping the LED flashlight when carrying a child or large object is minimal because the end 450 prevents the flashlight from falling to the floor. As described above, when the LED flashlight is suspended by the apical of the first hook portion 430A, a generally horizontal light beam casts itself upon an adjacent object the user is facing making it easier to see.

The foregoing description is illustrative of particular embodiments of the invention, but is not meant to be a limitation upon the practice thereof. The following claims, including all equivalents thereof, are intended to define the scope of the invention.

1. A flashlight comprising:
a battery having opposing surfaces of opposite polarity;
a light emitting diode having a first lead and a second lead extending therefrom, the leads adapted to engage the opposing surfaces of the battery;
a body adapted to receive said battery and said LED;
a frame having an apical hook portion attached to said body, the hook portion configured to orient said LED generally horizontal upon suspension of the flashlight by the hook portion.

2. The flashlight of claim 1 wherein said body comprises a lower panel and an upper panel with said frame therebetween.

3. The flashlight of claim 1 wherein said frame has two opposing hook portions.

4. The flashlight of claim 1 wherein the apical hook portion has a shape selected from the group consisting of: a triangle, a parallelogram and a semicircle.

5. The flashlight of claim 1 wherein said upper panel has a notch in the side such that a wall of the notch is defined by said frame and the notch is adapted to receive a lever for detaching said upper panel from said lower panel.

6. The flashlight of claim 1 wherein the first lead is in constant contact with a battery pole and said second lead contacts the opposing battery pole through a bridging connector.

7. The flashlight of claim 6 wherein the bridging connector is a leaf spring.

8. The flashlight of claim 1 wherein said frame is metal.

9. The flashlight of claim 1 further comprising a collar surrounding said LED.

10. The flashlight of claim 9 further comprising a spring clip urged into contact with the hook portion.

11. The flashlight of claim 1 wherein said battery is a lithium disc battery.

12. The flashlight of claim 1 wherein said LED is a gallium nitride LED.

13. The flashlight of claim 2 wherein at least one of said upper panel and said lower panel is translucent.

14. The flashlight of claim 2 wherein said upper panel and said lower panel are formed of thermoplastic material.

15. The flashlight of claim 1 wherein said frame is metal plated.

16. The flashlight of claim 1 wherein said lower panel has an abutment in contact with a rear portion of said LED.

17. A flashlight comprising:
a battery having opposing surfaces of opposite polarity;
a light emitting diode having a first lead and a second lead extending therefrom, the leads adapted to engage the opposing surfaces of the battery;
a lower panel adapted to receive said battery and said light emitting diode;
a frame having two opposing apical hook portions, said frame attached to said lower panel;
an upper panel having an upper surface, a side, an aperture extending through the upper surface and a fitting for attaching said upper panel to either said frame or said lower panel such that said frame is intermediate between said lower panel and said upper panel; and
a switch extending through the upper panel aperture to selectively activate said light emitting diode.

18. The flashlight of claim 17 wherein the apical hook portion has a shape selected from the group consisting of: a triangle, a parallelogram and a semicircle.

19. The flashlight of claim 17 wherein said upper panel has a notch in the side such that a wall of the notch is defined by said frame and the notch is adapted to receive a lever for detaching said upper panel from said lower panel.

20. The flashlight of claim 17 wherein said frame is metal.

21. The flashlight of claim 17 further comprising a spring clip urged into contact with at least one of the opposing hook portions.

22. The flashlight of claim 17 wherein at least one of said upper panel and said lower panel is translucent.

23. The flashlight of claim 17 wherein said upper panel and said lower panel are formed of thermoplastic material.

24. The flashlight of claim 17 wherein said frame is metal plated.

25. The flashlight of claim 17 further comprising a collar surrounding said LED.
